(19) United States
(12) Patent Application Publication
(10) Pub. No.: US 2026/0229874 A1
(43) Pub. Date: Aug. 6, 2026

(54) MOTOR DRIVER HAVING AUTOMATIC RELEASE PROTECTION MECHANISM AND MOTOR DRIVING METHOD THEREOF

(71) Applicant: ANPEC ELECTRONICS CORPORATION, HSINCHU (TW)

(72) Inventor: MING-JUNG TSAI, CHANGHUA COUNTY (TW)

(21) Appl. No.: 19/182,535

(22) Filed: Apr. 17, 2025

(30) Foreign Application Priority Data
Feb. 5, 2025 (TW) 114104052

(51) Int. Cl. H02H 7/08; H02H 7/085; H02P 3/06

(52) U.S. Cl. CPC H02H 7/0833; H02H 7/0854; H02P 3/06

(57) ABSTRACT

A motor driver having an automatic release protection mechanism and a motor driving method thereof. The motor driver includes an output stage circuit, a motor driving circuit and a rotational speed detector circuit. The output stage circuit includes a plurality of circuit switches each including a high-side switch and a low-side switch. The motor driving circuit performs a protection process in which the low-side switch of at least one of the plurality of circuit switches is turned off. The rotational speed detector circuit detects rotational speed of a motor at a plurality of detection time points. The motor driving circuit, according to the detected rotational speed of the motor, controls or modulates an ending time point and a time length that the protection process is performed.

### CROSS-REFERENCE TO RELATED PATENT APPLICATION

This application claims the benefit of priority to Taiwan Patent Application No. 114104052, filed on Feb. 5, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor driver, and more particularly to a motor driver having an automatic release protection mechanism and a motor driving method thereof.

### BACKGROUND OF THE DISCLOSURE

During operation, circuit components of electronic products generate heat, especially in enclosed casings or other confined spaces. The heat produced by the circuit components circulates within the enclosed casing, heating other circuit components and causing them to overheat and become damaged. Therefore, electronic products must be equipped with a fan to cool the circuit components.

When a conventional motor driver reduces the rotational speed of a fan motor from a high speed to a low speed, it first reduces the duty cycle of the plurality of waveforms of the conduction time signal output to the high-side switch, while increasing the duty cycle of the plurality of waveforms of the conduction time signal output to the low-side switch. Initially, the rotational speed of the motor does not immediately drop to a low value due to the motor's inertia characteristics, and the back electromotive force (BEMF) of the motor remains high. Meanwhile, during the prolonged conduction time of the low-side switch, the reverse current continues to increase until it reaches an excessive current value. As a result, once the low-side switch is turned off, even if the high-side switch is not conducting, the excessive reverse current still flows through the parasitic diode of the high-side switch and back into the high-side switch. This phenomenon causes damage to the input capacitor or other circuit components at the input end of the conventional motor driver.

To prevent the aforementioned situation, when a conventional motor driver intends to reduce the motor's rotational speed from a high speed to a low speed, it keeps the low-side switch in an off state to prevent the reverse current from increasing to an excessive current value. However, conventional motor drivers fail to properly control the duration for which the low-side switch remains in the off state. As a result, the duration may be either too long or too short, making it impossible to both reduce reverse current and achieve high driving efficiency for the motor at the same time.

### SUMMARY OF THE DISCLOSURE

To address the problems in the relevant art, the present disclosure provides a motor driver having an automatic release protection mechanism. The motor driver includes an output stage circuit, a motor driving circuit, and a rotational speed detector circuit. The output stage circuit comprises a plurality of circuit switches, each including a high-side switch and a low-side switch. The first terminal of the high-side switch is coupled to an input voltage, and the first terminal of the low-side switch is connected to the second terminal of the high-side switch. The second terminal of the low-side switch is grounded. A node between the second terminal of the low-side switch and the first terminal of the high-side switch is connected to one terminal of the motor. The motor driving circuit is connected to the control terminals of the high-side switches and the control terminals of the low-side switches. The motor driving circuit is configured to perform a protection process, in which the low-side switch of at least one of the plurality of circuit switches is turned off. The rotational speed detector circuit is connected to the motor driving circuit and is configured to detect the rotational speed of the motor at a plurality of detection time points as a plurality of detected rotational speeds. The motor driving circuit, according to the plurality of detected rotational speeds, controls or modulates the ending time point and duration of the protection process.

Additionally, to address the problems in the relevant art, the present disclosure provides a motor driving method having an automatic release protection mechanism. The motor driving method is applicable to a motor, where the motor is connected to a plurality of circuit switches. Each of the plurality of circuit switches includes a high-side switch and a low-side switch. The first terminal of the high-side switch is coupled to an input voltage, and the first terminal of the low-side switch is connected to the second terminal of the high-side switch. The second terminal of the low-side switch is grounded. A node between the second terminal of the low-side switch and the first terminal of the high-side switch is connected to one terminal of the motor. The motor driving method with an automatic release protection mechanism comprises processes of: performing a protection process in which the low-side switch of at least one of the plurality of circuit switches is turned off; detecting the rotational speed of the motor at a plurality of detection time points as a plurality of detected rotational speeds; and controlling or modulating the ending time point and duration of the protection process according to the plurality of detected rotational speeds.

As described above, the present disclosure provides a motor driver and a motor driving method having an automatic release protection mechanism. The motor driver and motor driving method of the present disclosure can appropriately control the ending time point and duration of the protection process, particularly by terminating the protection process at an appropriate ending time point to prevent reverse current from flowing back into the circuit components at the input end of the motor driver. This not only improves the efficiency of the circuit components at the input end of the motor driver, but also achieves high driving efficiency for the motor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver having an automatic release protection mechanism according to a first embodiment of the present disclosure.

FIG. 2 is a flowchart illustrating processes of a motor driving method having an automatic release protection mechanism according to the first embodiment of the present disclosure.

FIG. 3 is a block diagram of a motor driver having an automatic release protection mechanism according to a second embodiment of the present disclosure.

FIG. 4 is a block diagram of a motor driver having an automatic release protection mechanism according to a third embodiment of the present disclosure.

FIG. 5 is a flowchart illustrating processes of a motor driving method having an automatic release protection mechanism according to the third embodiment of the present disclosure.

FIG. 6 is a circuit diagram of the output stage circuit and the motor in the motor driver having an automatic release protection mechanism according to the first to third embodiments of the present disclosure.

FIG. 7 is a schematic diagram illustrating the current flow direction in the output stage circuit of the motor driver having an automatic release protection mechanism under protection mode according to the first to third embodiments of the present disclosure.

FIG. 8 is a waveform diagram of signals generated by the motor driver and the motor driving method having an automatic release protection mechanism according to the first to third embodiments of the present disclosure.

FIG. 9 is another waveform diagram of signals generated by the motor driver and the motor driving method having an automatic release protection mechanism according to the first to third embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

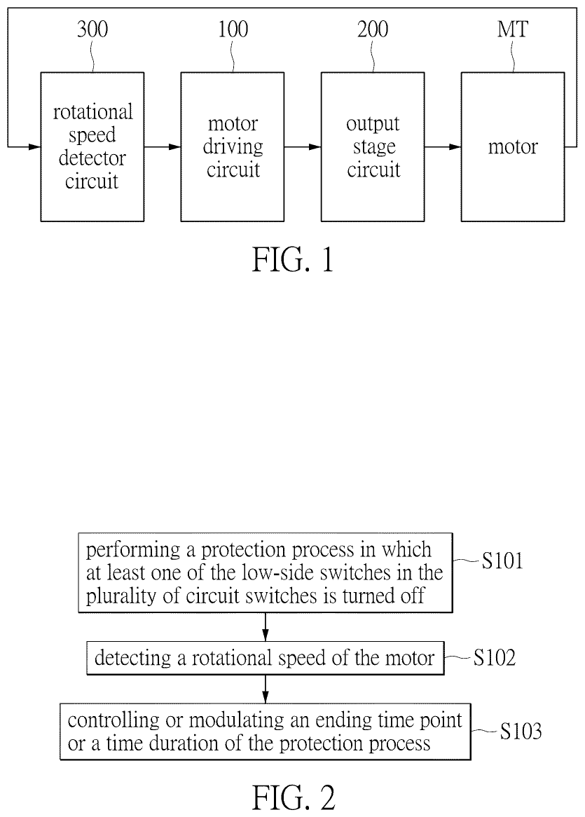

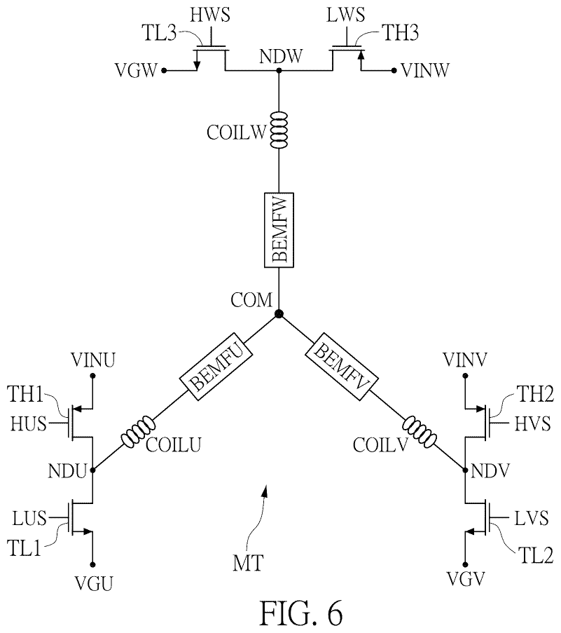

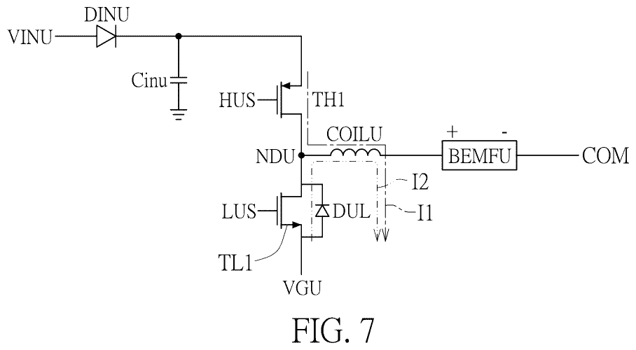

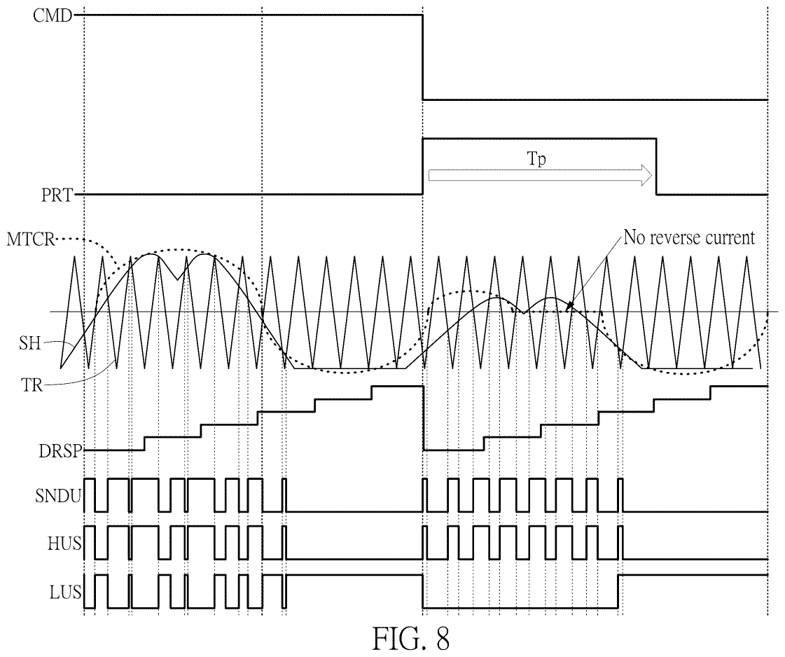

Reference is made to FIG. 1, FIG. 2, FIG. 6, and FIG. 7. FIG. 1 is a block diagram of a motor driver having an automatic release protection mechanism according to a first embodiment of the present disclosure, FIG. 2 is a flowchart illustrating processes of a motor driving method having an automatic release protection mechanism according to the first embodiment of the present disclosure, FIG. 6 is a circuit diagram of the output stage circuit and the motor in the motor driver having an automatic release protection mechanism according to the first to third embodiments of the present disclosure, and FIG. 7 is a schematic diagram illustrating the current flow direction in the output stage circuit of the motor driver having an automatic release protection mechanism under protection mode according to the first to third embodiments of the present disclosure.

As shown in FIG. 1, in the first embodiment, the motor driver of the present disclosure includes a motor driving circuit 100, an output stage circuit 200, and a rotational speed detector circuit 300. The motor driving circuit 100 is connected to the output stage circuit 200 and the rotational speed detector circuit 300. The output stage circuit 200 is connected to a motor MT.

The motor driver of the present disclosure is applicable to the motor MT as shown in FIG. 1. This motor MT, for example but not limited to, may be the same as the three-phase motor shown in FIG. 6.

The motor driver of the present disclosure, as shown in FIG. 1, is suitable for performing the steps S101 to S103 included in the motor driving method of the present disclosure, as illustrated in FIG. 2.

As shown in FIG. 1, the output stage circuit 200 may include the plurality of circuit switches, as shown in FIG. 6, in which each circuit switch includes a high-side switch and a low-side switch. For example, one of the plurality of circuit switches in the output stage circuit 200 includes a first high-side switch TH1 and a first low-side switch TL1, another circuit switch includes a second high-side switch TH2 and a second low-side switch TL2, and yet another circuit switch includes a third high-side switch TH3 and a third low-side switch TL3.

As shown in FIG. 6, the first terminal of the first high-side switch TH1 is coupled to a first input voltage VINU. The first terminal of the first low-side switch TL1 is connected to the second terminal of the first high-side switch TH1. A first node NDU, which is between the first terminal of the first low-side switch TL1 and the second terminal of the first high-side switch TH1, is connected to the first terminal of a first phase coil COILU of the U phase of the motor MT. The second terminal of the first low-side switch TL1 is coupled to a first reference voltage VGU.

The first terminal of the second high-side switch TH2 is coupled to a second input voltage VINV. The first terminal of the second low-side switch TL2 is connected to the second terminal of the second high-side switch TH2. A second node NDV, which is between the first terminal of the second low-side switch TL2 and the second terminal of the second high-side switch TH2, is connected to the first terminal of a second phase coil COILV of the V phase of the motor MT. The second terminal of the second low-side switch TL2 is coupled to a second reference voltage VGV.

The first terminal of the third high-side switch TH3 is coupled to a third input voltage VINW. The first terminal of the third low-side switch TL3 is connected to the second terminal of the third high-side switch TH3. A third node NDW, which is between the first terminal of the third low-side switch TL3 and the second terminal of the third high-side switch TH3, is connected to the first terminal of a third phase coil COILW of the W phase of the motor MT. The second terminal of the third low-side switch TL3 is coupled to a third reference voltage VGW.

The second terminals of the first phase coil COILU, the second phase coil COILV, and the third phase coil COILW of the motor MT are connected to a common node COM.

It is noteworthy that when the motor driving circuit 100 reduces the rotational speed of the motor MT, the voltage of the first phase coil COILU of the motor MT gradually decreases, but the rotational speed of the motor MT does not immediately drop to a low value. Due to the inertia characteristics of the motor MT, the back electromotive force (BEMF) of the U phase of the motor MT, denoted as BEMFU, remains large and is proportional to the rotational speed of the motor MT. Meanwhile, since the duty cycle of the low-side switch (e.g., the first low-side switch TL1 in FIG. 7) in the plurality of circuit switches is high, or its conduction time is long, the reverse current continuously increases to a high excessive current value.

If a conventional motor driver does not include a unidirectional conduction component with a single conduction characteristic, the excessive reverse current will flow into the high-side switch and then back into the input power source supplying the first input voltage VINU, causing damage to the input power source. However, if the conventional motor driver is equipped with a unidirectional conduction component, such as the diode DINU shown in FIG. 7, the excessive reverse current will instead flow into the input capacitor Cinu, as shown in FIG. 7, causing damage to the input capacitor Cinu. Consequently, the conventional motor driver fails to operate normally.

To prevent the aforementioned situation, when the motor driving circuit 100 reduces the rotational speed of the motor MT, the motor driving circuit 100 performs a protection process (step S101 in FIG. 2). In this protection process, the motor driving circuit 100 turns off the low-side switch of at least one of the plurality of circuit switches, such as the first low-side switch TL1 shown in FIG. 7 (as in step S101 of FIG. 2). As a result, as illustrated in FIG. 7, the current I1 flows sequentially from the first input voltage VINU through the diode DINU, the first high-side switch TH1, and the first phase coil COILU of the U phase of the motor MT. Meanwhile, due to the continuity of the current in the first phase coil COILU, another current I2 sequentially flows through the body diode DUL of the first low-side switch TL1 to the first phase coil COILU of the U phase of the motor MT. Once the rotational speed of the motor MT has stabilized, meaning its rate of change is small or ceases, the motor driving circuit 100 stops performing the protection process and resumes normal switching of the plurality of circuit switches to drive the motor MT in normal operation.

It is noteworthy that if the aforementioned protection process is terminated before the motor MT reaches a steady state while its rotational speed is still decreasing in the transient change process, the protection time will be too short, and the previously described damage to the motor driver may still occur. Conversely, if the motor MT has already reached a steady state but the protection process continues, the protection time will be too long, leading to excessive reverse current flowing through the body diode (DUL) of the first low-side switch TL1, which may cause overheating of the first low-side switch TL1 and reduce the operational efficiency of the motor driver. Furthermore, when the first low-side switch TL1 switches from an off state to an on state, the instantaneous current variation through the first low-side switch TL1 may not change as smoothly as expected, preventing the motor MT from reaching the target rotational speed.

Therefore, when the motor driving circuit 100 performs the protection process, the rotational speed detector circuit 300 detects the rotational speed of the motor MT a plurality of times and outputs each detected rotational speed as a detected speed (step S102 in FIG. 2).

The motor driving circuit 100, based on the plurality of detected rotational speeds obtained from the rotational speed detector circuit 300, controls or modulates the ending time point (release time point) and duration of the protection process (step S103 in FIG. 2).

In other words, compared to conventional motor drivers and motor driving methods, the motor driver and motor driving method of the present disclosure provide an automatic release protection mechanism. The motor driver and motor driving method of the present disclosure can more appropriately control the performance time of the protection process. For example, the motor driving circuit 100 of the present disclosure can extend the performance duration of the protection process until the motor MT reaches a steady state (e.g., when the rotational speed of the motor MT stabilizes). Additionally, the motor driving circuit 100 can terminate the protection process earlier when the motor MT has already reached a steady state, allowing the motor to resume normal operation without the need for protection. Thus, the motor driver and motor driving method of the present disclosure prevent reverse current from flowing back into the circuit components at the input end of the motor driver while achieving high driving efficiency for the motor MT.

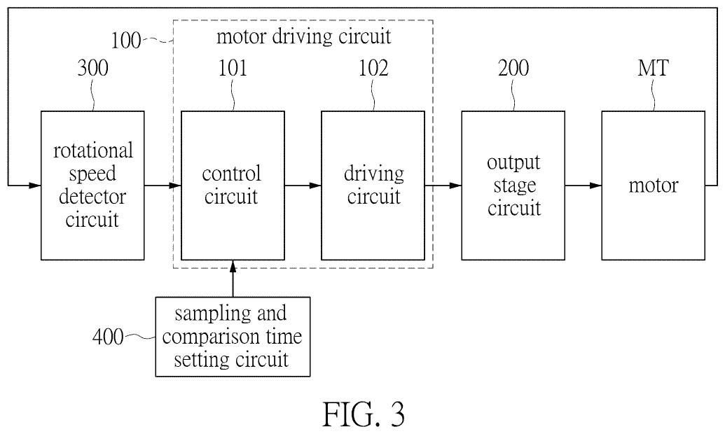

Reference is made to FIG. 3 and FIG. 6. FIG. 3 is a block diagram of a motor driver having an automatic release protection mechanism according to the second embodiment of the present disclosure, and FIG. 6 is a circuit diagram of the output stage circuit and the motor in the motor driver having an automatic release protection mechanism according to the first to third embodiments of the present disclosure.

The present embodiment of the present disclosure having the same content as the previous embodiment will not be redundantly described herein.

As shown in FIG. 3, in the second embodiment, the motor driver of the present disclosure includes not only the motor driving circuit 100, the output stage circuit 200, and the rotational speed detector circuit 300, but also a sampling and comparison time setting circuit 400. The motor driving circuit 100 includes a control circuit 101 and a driving circuit 102.

The control circuit 101 is connected to the rotational speed detector circuit 300, the driving circuit 102, and the sampling and comparison time setting circuit 400. The rotational speed detector circuit 300 is installed on the motor MT, in contact with the motor MT, or connected to the motor MT. The output stage circuit 200 is connected to the driving circuit 102 and the motor MT.

As shown in FIG. 3, the driving circuit 102 is connected to the control terminals of the plurality of high-side switches and the plurality of low-side switches of the output stage circuit 200, such as the control terminals of the first high-side switch TH1, the second high-side switch TH2, the third high-side switch TH3, the first low-side switch TL1, the second low-side switch TL2, and the third low-side switch TL3, as illustrated in FIG. 6.

The rotational speed detector circuit 300 detects the rotational speed of the motor MT at the plurality of detection time points.

When the detected rotational speed of the motor MT changes from a first rotational speed to a second rotational speed, and the difference between the first and second rotational speeds exceeds a rotational speed threshold, the control circuit 101 controls the driving circuit 102 to perform the aforementioned protection process.

The sampling and comparison time setting circuit 400 sets the plurality of sampling time points following the initial time point of the protection process.

The control circuit 101 retrieves the plurality of sampling time points set by the sampling and comparison time setting circuit 400 and acquires the plurality of detected rotational speeds of the motor MT at the plurality of detection time points as the plurality of detected rotational speeds. The plurality of detection time points include the plurality of sampling time points. The control circuit 101 samples the plurality of detected rotational speeds at the plurality of sampling time points to obtain the plurality of sampled rational speeds.

The rotational speed detector circuit 300, based on the plurality of sampled rational speeds, controls or modulates the ending time point and duration of the protection process performed by the driving circuit 102.

For example, the control circuit 101 compares the sampled rotational speeds at every two sampling time points to determine whether the motor MT has transitioned from a transient state to a steady state, thereby deciding whether to stop performing the protection process through the driving circuit 102.

When the difference between the sampled rotational speeds at any two sampling time points is not equal to zero or is greater than a rotational speed threshold, the control circuit 101 determines that the motor MT is still in a transient state. Consequently, the control circuit 101 continues comparing subsequent detected rotational speeds and keeps controlling the driving circuit 102 to perform the protection process.

When the difference between the sampled rotational speeds at any two sampling time points is equal to zero or smaller than a rotational speed threshold, the control circuit 101 determines that the motor MT has transitioned to a steady state. As a result, the control circuit 101 stops comparing subsequent detected sampled rational speeds and controls the driving circuit 102 to stop performing the protection process.

For example, the control circuit 101 may set or obtain a predetermined time duration. If the control circuit 101 determines that the motor MT transitions from a transient state to a steady state before this predetermined time duration has elapsed, the control circuit 101 shortens the performance duration of the protection process, making the actual performance duration of the protection process shorter than the predetermined time duration. Conversely, if the control circuit 101 determines that the motor MT has not transitioned from a transient state to a steady state after the predetermined time duration has elapsed, the control circuit 101 extends the original performance duration of the protection process, making the actual performance duration longer than the predetermined time duration.

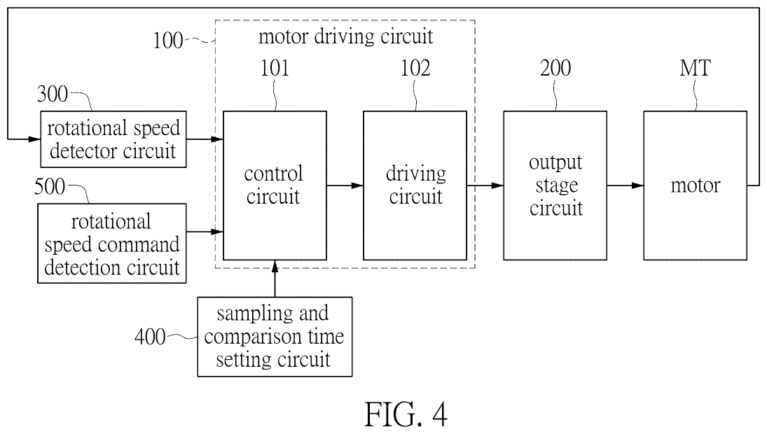

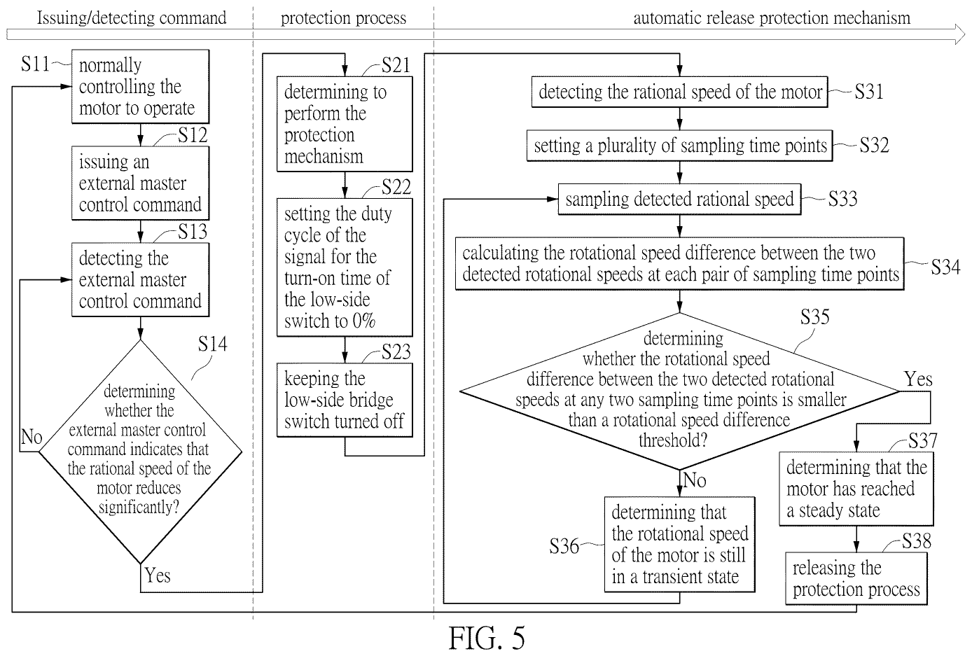

Reference is made to FIG. 4 and FIG. 5. FIG. 4 is a block diagram of a motor driver having an automatic release protection mechanism according to the third embodiment of the present disclosure, and FIG. 5 is a flowchart illustrating processes of a motor driving method having an automatic release protection mechanism according to the third embodiment of the present disclosure.

The third embodiment of the present disclosure shares similarities with the first and second embodiments, which will not be redundantly described herein. As shown in FIG. 4, the motor driver in the third embodiment of the present disclosure includes, in addition to the motor driving circuit 100, the output stage circuit 200, the rotational speed detector circuit 300, the sampling and comparison time setting circuit 400, and furthermore, a rotational speed command detection circuit 500. The motor driving circuit 100 includes a control circuit 101 and a driving circuit 102. The rotational speed command detection circuit 500 is connected to the control circuit 101.

The motor driving method of the present disclosure, as shown in FIG. 5, includes steps S11-S14, S21-S23, and S31-S38, which can be performed by the motor driver shown in FIG. 4. In steps S11-S14, detection and issuance of a master control command occur. In steps S21-S23, the protection process is performed. Specifically, in steps S31-S38, the ending time point (release time point) of the protection process is controlled or modulated. In practice, one or more of the steps S11-S14, S21-S23, and S31-S38 in FIG. 5 may be omitted.

In normal operation mode, the control circuit 101 controls the driving circuit 102 to normally drive the first high-side switch TH1, the second high-side switch TH2, the third high-side switch TH3, the first low-side switch TL1, the second low-side switch TL2, and the third low-side switch TL3 (step S11 in FIG. 5).

The rotational speed command detection circuit 500 detects an external master control command issued by an external master control device and outputs a master control command detection signal (steps S12 and S13 in FIG. 5).

When the rotational speed command detection circuit 500 detects that an external master control command indicates that the rotational speed of the motor MT should be reduced from a first rotational speed to a second rotational speed, and that the difference between the first and second rotational speeds exceeds a rotational speed difference threshold, the master control command detection signal output by the rotational speed command detection circuit 500 includes a large deceleration command message.

The control circuit 101, upon receiving a master control command detection signal from the rotational speed command detection circuit 500, controls the driving circuit 102 to drive the output stage circuit 200.

The control circuit 101 determines whether the master control command detection signal received from the rotational speed command detection circuit 500 contains a large deceleration command signal indicating that the rotational speed of the motor MT should be reduced.

If the control circuit 101 determines that the external master control command does not indicate a significant reduction in the rotational speed of the motor MT, the control circuit 101 maintains the normal operation mode and continues to control the driving circuit 102 to normally drive the first high-side switch TH1, the second high-side switch TH2, the third high-side switch TH3, the first low-side switch TL1, the second low-side switch TL2, and the third low-side switch TL3 (step S11 in FIG. 5).

Conversely, if the control circuit 101 determines that the external master control command indicates a significant reduction in the rotational speed of the motor MT, the control circuit 101 decides to control the driving circuit 102 to perform the protection process (step S21 in FIG. 5).

It is noteworthy that in the protection process, the control circuit 101 controls the driving circuit 102 to reduce the duty cycle of the waveform of the low-side conduction time signal of at least one of the plurality of circuit switches, including a low-side switch (such as the first low-side switch TL1 in FIG. 7), to 0% (step S22 in FIG. 5). As a result, the first low-side switch TL1 remains in an off state during the protection process (step S23 in FIG. 5).

It is also noteworthy that when performing the protection process (steps S21-S23 in FIG. 5), the motor driver of the present disclosure can immediately determine the automatic release protection mechanism's time point (i.e., the ending time point/release time point of the protection process) (steps S31-S38 in FIG. 5), as explained in detail below.

The rotational speed detector circuit 300 detects the rotational speed of the motor MT at the plurality of detection time points and outputs each detected rotational speed as a detected speed (step S31 in FIG. 5).

The sampling and comparison time setting circuit 400 sets the plurality of sampling time points (step S32 in FIG. 5).

The control circuit 101 samples two detected rotational speeds at any two of the plurality of sampling time points (step S33 in FIG. 5) and calculates the rotational speed difference between the two detected rotational speeds at each pair of sampling time points (step S34 in FIG. 5).

The control circuit 101 determines whether the rotational speed difference between the two detected rotational speeds at any two sampling time points is smaller than a rotational speed difference threshold (step S35 in FIG. 5).

If the rotational speed difference between two detected rotational speeds at any two sampling time points of the motor MT is not smaller than a rotational speed threshold, the control circuit 101 determines that the rotational speed of the motor MT is still decreasing and thus concludes that the motor MT is in a transient state (step S36 in FIG. 5). Subsequently, the control circuit 101 continues sampling two detected rotational speeds at any two sampling time points (step S33 in FIG. 5), ensuring that at least one of the sampling time points in the new sampling pair is different from the previous sampling pair.

Conversely, if the rotational speed difference between two detected rotational speeds at any two sampling time points of the motor MT is smaller than the rotational speed threshold, the control circuit 101 determines that the rotational speed of the motor MT has either stopped changing or is changing insignificantly and thus concludes that the motor MT has reached a steady state (step S37 in FIG. 5).

When the control circuit 101 determines that the motor MT has reached a steady state (step S37 in FIG. 5), the control circuit 101 controls the driving circuit 102 to stop performing the protection process (steps S21- S23 in FIG. 5), thereby releasing the protection process. After the protection process is released, the control circuit 101 may control the driving circuit 102 to operate in normal mode, thereby normally driving the first high-side switch TH1, the second high-side switch TH2, the third high-side switch TH3, the first low-side switch TL1, the second low-side switch TL2, and the third low-side switch TL3 (step S11 in FIG. 5).

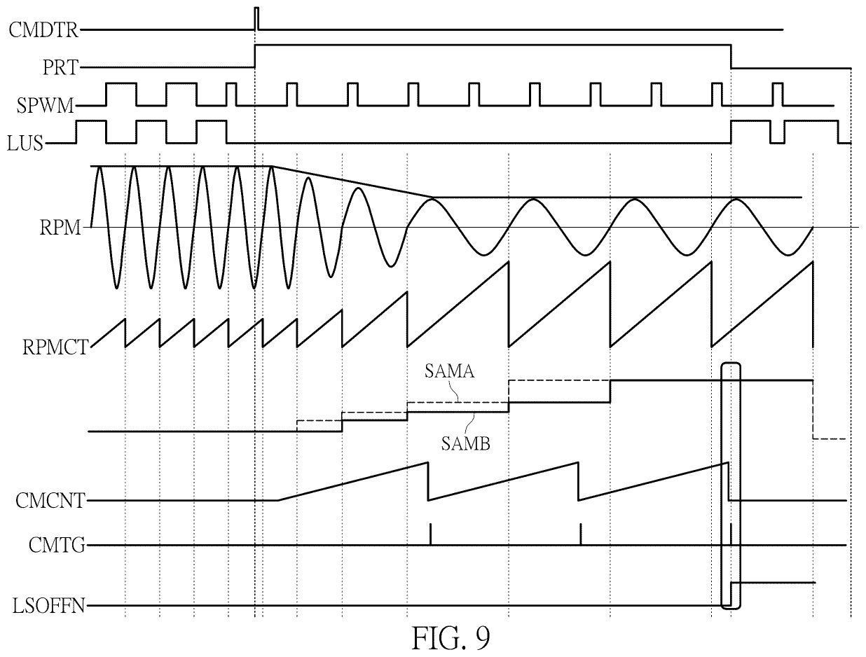

Reference is made to FIGS. 4 to 9. FIGS. 8 and 9 are waveform diagrams of signals generated by the motor driver and the motor driving method having an automatic release protection mechanism according to the first to third embodiments of the present disclosure.

As shown in FIG. 4, the driving circuit 102 of the motor driver of the present disclosure may generate the plurality of first waveform signals based on control signals received from the control circuit 101. Each of the plurality of first waveform signals may include the plurality of third harmonic waveforms similar to the first waveform signal SH shown in FIG. 8, or in practice, may include the plurality of sinusoidal waveforms.

The driving circuit 102 may acquire or generate the plurality of second waveform signals. Each of the plurality of second waveform signals may include the plurality of triangular waveforms similar to the second waveform signal TR shown in FIG. 8, or in practice, may include the plurality of sawtooth waveforms.

The driving circuit 102 may compare the voltage levels of the plurality of first waveform signals with the voltage levels of the plurality of second waveform signals to respectively set the duty cycles of the plurality of waveforms of the plurality of high-side conduction time signals. Each of the plurality of waveforms of the high-side conduction time signals may include the plurality of pulses, the plurality of square waves, or any combination thereof.

The driving circuit 102 outputs the plurality of high-side conduction time signals to the control terminals of the first high-side switch TH1, the second high-side switch TH2, and the third high-side switch TH3, respectively. The voltage levels of the plurality of low-side conduction time signals output by the driving circuit 102 to the control terminals of the first low-side switch TL1, the second low-side switch TL2, and the third low-side switch TL3 may be opposite to the voltage levels of the plurality of high-side conduction time signals.

When the rotational speed command detection circuit 500 detects that an external master control command CMD issued by an external master control device indicates that the rotational speed of the motor MT has not decreased and remains at a first level, for example, a high logic level as shown in FIG. 8, the rotational speed command detection circuit 500 outputs a master control command detection signal CMDTR having a second level, such as a low logic level as shown in FIG. 9.

Subsequently, based on the master control command detection signal CMDTR received from the rotational speed command detection circuit 500, which has a second level (e.g., a low logic level), the control circuit 101 outputs a protection process trigger signal PRT having a second level, such as the low logic level shown in FIG. 8.

Next, based on the protection process trigger signal PRT received from the control circuit 101, which has a second level (e.g., a low logic level as shown in FIG. 8), the driving circuit 102 drives the output stage circuit 200 to remain in normal mode instead of switching to protection mode.

During each complete cycle (including both the working and non-working cycles) of each waveform in the first waveform signal SH shown in FIG. 8, the control circuit 101 controls the driving circuit 102 to drive the output stage circuit 200, thereby controlling the six-step driving of the motor MT, such as a three-phase motor, as indicated by the motor six-step driving signal DRSP shown in FIG. 8.

In normal mode, the driving circuit 102 alternately switches the high-side switch and low-side switch of each circuit switch complementarily. As shown in FIGS. 7 to 9, the voltage level of the high-side conduction time signal HUS output to the control terminal of the first high-side switch TH1 is opposite to the voltage level of the low-side conduction time signal LUS output to the first low-side switch TL1. As a result, the driving circuit 102 alternately switches the first high-side switch TH1 and the first low-side switch TL1 complementarily.

The high-side conduction time signal HUS shown in FIG. 8 may be replaced with a pulse-width modulation (PWM) signal SPWM as shown in FIG. 9. The signal at the first node NDU, which is between the second terminal of the first high-side switch TH1 and the second terminal of the first low-side switch TL1, as shown in FIG. 7, may be the same as the first node signal SNDU shown in FIG. 8.

When the rotational speed command detection circuit 500 detects that an external master control command CMD issued by an external master control device indicates that the rotational speed of the motor MT has decreased to a second level, for example, a low logic level as shown in FIG. 8, the rotational speed command detection circuit 500 outputs a master control command detection signal CMDTR having a first level, such as a high level or a pulse as shown in FIG. 9.

Subsequently, based on the master control command detection signal CMDTR received from the rotational speed command detection circuit 500, which has a first level (e.g., a high level or a pulse as shown in FIG. 9), the control circuit 101 outputs a protection process trigger signal PRT having a pulse or a first level, such as the high logic level shown in FIG. 8.

Next, based on the protection process trigger signal PRT received from the control circuit 101, which has a pulse or a first level (e.g., a high logic level as shown in FIG. 8), the driving circuit 102 switches the output stage circuit 200 from normal mode to protection mode and maintains the output stage circuit 200 in protection mode for the duration of the working cycle of the waveform of the protection process trigger signal PRT.

In other words, as shown in FIG. 8, the duty cycle of the waveform of the protection process trigger signal PRT defines the protection process performance time Tp, during which the output stage circuit 200 remains in the protection mode.

When the output stage circuit 200 switches from normal mode to protection mode, as shown in FIGS. 8 and 9, the driving circuit 102 reduces the duty cycle of the waveform of the low-side conduction time signal LUS to 0% during the protection process performance time Tp to keep the first low-side switch TL1 turned off. As a result, as shown in FIG. 8, no reverse current is generated in the motor current signal MTCR during the protection process performance time Tp.

The rotational speed detector circuit 300 can repeatedly detect the rotational speed RPM of the motor MT and output it to the control circuit 101. The control circuit 101 can accumulate the number of times the rotational speed detector circuit 300 detects the rotational speed of the motor MT to generate a rotational speed detection count value and, based on the plurality of generated rotational speed detection count values, generate a rotational speed detection count signal RPMCT as shown in FIG. 9.

The sampling and comparison time setting circuit 400 can set the plurality of sampling time points after the rising or falling edge of a pulse of the master control command detection signal CMDTR. For example, the plurality of sampling time points set by the sampling and comparison time setting circuit 400 include the plurality of first sampling time points and the plurality of second sampling time points.

The sampling and comparison time setting circuit 400 can output a first sampling time indication signal SAMA based on the plurality of first sampling time points, as shown in FIG. 9. The plurality of time points at which the first sampling time indication signal SAMA transitions from a low level to a high level correspond to the plurality of first sampling time points.

The sampling and comparison time setting circuit 400 can output a second sampling time indication signal SAMB based on the plurality of second sampling time points, as shown in FIG. 9. The plurality of time points at which the second sampling time indication signal SAMB transitions from a low level to a high level correspond to the plurality of second sampling time points.

The control circuit 101 samples the rotational speed RPM of the motor MT detected by the rotational speed detector circuit 300 at each of the plurality of sampling time points (including the plurality of first sampling time points and the plurality of second sampling time points).

The sampling and comparison time setting circuit 400 can set a sampling comparison count threshold value, which may be, for example, equal to the maximum value (e.g., the peak value) of the plurality of values of a sampling comparison count threshold signal CMCNT, as shown in FIG. 9.

The control circuit 101 can accumulate the number of times or the duration for which the rotational speed RPM of the motor MT is sampled to generate a sampling comparison count value. Based on the accumulated sampling comparison count value, the control circuit 101 generates a sampling comparison trigger signal CMTG, as shown in FIG. 9.

When the accumulated sampling comparison count value reaches the sampling comparison count threshold value, the control circuit 101 generates a sampling comparison trigger signal CMTG with a pulse or a first level, such as a high level.

During the working cycle of each pulse of the plurality of waveforms of the sampling comparison trigger signal CMTG, the control circuit 101 calculates the difference between the rotational speed RPM of the motor MT sampled at the first sampling time point and the rotational speed RPM of the motor MT sampled at the second sampling time point as a rotational speed difference value and compares this rotational speed difference value with a rotational speed difference threshold.

Before the rotational speed difference value becomes smaller than the rotational speed difference threshold, the control circuit 101 continues performing the protection process during the working cycle of the waveform of the protection process trigger signal PRT, i.e., during the protection process performance time Tp. The control circuit 101 continues sampling subsequent detected rotational speeds of the motor MT and calculating rotational speed differences between the first and second sampling time points in subsequent iterations.

When the currently calculated rotational speed difference between the rotational speed RPM of the motor MT at the first sampling time point and the rotational speed RPM of the motor MT at the second sampling time point becomes smaller than the rotational speed difference threshold, the control circuit 101 outputs a protection process trigger signal PRT to the driving circuit 102, transitioning from a high level to a low level. Based on the low-level protection process trigger signal PRT, the driving circuit 102 switches the output stage circuit 200 from protection mode back to normal mode. Additionally, or alternatively, the control circuit 101 can output a high-level low-side switch-off release signal LSOFFN, based on which the driving circuit 102 switches the output stage circuit 200 from protection mode back to normal mode.

In summary, the present disclosure provides a motor driver and a motor driving method having an automatic release protection mechanism. The motor driver and motor driving method of the present disclosure can appropriately control the ending time point and duration of the protection process. In particular, the protection process is released at an appropriate ending time point to prevent reverse current from flowing back into the circuit components at the input end of the motor driver, thereby achieving high efficiency in driving the motor.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver having an automatic release protection mechanism, comprising:
an output stage circuit, including a plurality of circuit switches, each of the plurality of circuit switches comprising:
a high-side switch, wherein a first terminal of the high-side switch is coupled to an input voltage; and
a low-side switch, wherein a first terminal of the low-side switch is connected to a second terminal of the high-side switch, a second terminal of the low-side switch is grounded, and a node between the second terminal of the low-side switch and the first terminal of the high-side switch is connected to one terminal of a motor;
a motor driving circuit, connected to control terminals of the high-side switches and control terminals of the low-side switches, and configured to perform a protection process in which at least one of the low-side switches in the plurality of circuit switches is turned off; and
a rotational speed detector circuit, connected to the motor driving circuit, and configured to detect a rotational speed of the motor at a plurality of detection time points as a plurality of detected rotational speeds;
wherein the motor driving circuit is configured to control or modulate an ending time point and a time duration of the protection process based on the plurality of detected rotational speeds.

2. The motor driver having an automatic release protection mechanism according to claim 1, wherein the motor driving circuit comprises:
a driving circuit, connected to the control terminals of the high-side switches and the low-side switches, and configured to perform the protection process on at least one of the plurality of circuit switches; and
a control circuit, connected to the rotational speed detector circuit and the driving circuit, and configured to control the ending time point and the time duration of the protection process based on the plurality of detected rotational speeds.

3. The motor driver having an automatic release protection mechanism according to claim 1, wherein, when the motor driving circuit determines that, based on the plurality of detected rotational speeds, the motor has transitioned from a transient state to a steady state, the motor driving circuit stops performing the protection process.

4. The motor driver having an automatic release protection mechanism according to claim 3, wherein, when a rotational speed difference between two detected rotational speeds at any two of a plurality of sampling time points is smaller than a rotational speed difference threshold, the motor driving circuit stops performing the protection process.

5. The motor driver having an automatic release protection mechanism according to claim 4, further comprising:
a sampling and comparison time setting circuit, connected to the motor driving circuit, and configured to set the plurality of sampling time points after an initial time point of the protection process.

6. The motor driver having an automatic release protection mechanism according to claim 1, further comprising:
a rotational speed command detection circuit, connected to the motor driving circuit, and configured to detect an external master control command;
wherein, when the external master control command indicates that the rotational speed of the motor is reduced from a first speed to a second speed and a difference between the first speed and the second speed is greater than a rotational speed difference threshold, the motor driving circuit performs the protection process.

7. A motor driving method having an automatic release protection mechanism, applicable to a motor, wherein the motor is connected to a plurality of circuit switches, each of the plurality of circuit switches comprises a high-side switch and a low-side switch, a first terminal of the high-side switch is coupled to an input voltage, a first terminal of the low-side switch is connected to a second terminal of the high-side switch, a second terminal of the low-side switch is grounded, and a node between the second terminal of the low-side switch and the first terminal of the high-side switch is connected to one terminal of the motor, the motor driving method having an automatic release protection mechanism comprising processes of:
performing a protection process in which at least one of the low-side switches in the plurality of circuit switches is turned off;
detecting a rotational speed of the motor at a plurality of detection time points as a plurality of detected rotational speeds; and
controlling or modulating an ending time point and a time duration of the protection process based on the plurality of detected rotational speeds.

8. The motor driving method having an automatic release protection mechanism according to claim 7, further comprising processes of:
determining, based on the plurality of detected rotational speeds, whether the motor has transitioned from a transient state to a steady state; if not, continuing to perform the protection process; if yes, stopping performance of the protection process.

9. The motor driving method having an automatic release protection mechanism according to claim 7, further comprising processes of:
calculating a rotational speed difference between two detected rotational speeds at any two of a plurality of sampling time points; and
determining whether the rotational speed difference is smaller than a rotational speed difference threshold; if not, continuing to perform the protection process; if yes, stopping the performance of the protection process.

10. The motor driving method having an automatic release protection mechanism according to claim 7, further comprising processes of:
detecting whether an external master control command indicates that the rotational speed of the motor is reduced from a first speed to a second speed and a difference between the first speed and the second speed is greater than a rotational speed difference threshold; if yes, performing the protection process; if not, not performing the protection process.
